(19) United States
(12) Patent Application Publication
(10) Pub. No.: US 2010/0289777 A1
(43) Pub. Date: Nov. 18, 2010

(54) Wheel structure for an electronic input device

(75) Inventors: Cheng-Che Tsai, Sanchung (TW); Ding-Teng Hou, Sanchung (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., Sanchung City (TW)

(21) Appl. No.: 12/662,922

(22) Filed: May 12, 2010

(30) Foreign Application Priority Data
May 14, 2009 (TW) 098115950

(51) Int. Cl. G09G 5/00

(52) U.S. Cl. 345/184

(57) ABSTRACT

A wheel structure for an electronic input device has a housing, and two supporting brackets and a circuit board mounted in the housing. A wheel assembly is supported by the supporting brackets and has a wheel. The wheel has an axle having a pivot end mounted through one supporting bracket and a mounting end mounted through a bearing disposed on the other supporting bracket. Moreover, a resilient assembly is disposed under and abuts the pivot end of the axle of the wheel. The wheel assembly is floatingly disposed in the housing so a friction applied to the wheel assembly is reduced. Therefore, the user is able to rotate the wheel assembly at high-speed with a light force. Furthermore, material and assembling costs and an assembling time of the wheel structure are saved.

### BACKGROUND OF THE INVENTION

1. Field of the Invention

The present invention relates to a wheel structure for an electronic input device, especially to a wheel structure that has a wheel assembly mounted in a housing in a nearly floating way so a user is able to rotate the wheel assembly with light force.

2. Description of the Prior Art(s)

Input devices are used to input instructions or data into an electronic apparatus to indicate the electronic apparatus how to work and show expected results. A wheel structure is used for the input devices and has a sensor sensing rotating distances and rotating directions of the wheel structure and then sending a signal to the electronic apparatus so an image shown on a screen of the electronic apparatus is moved.

A conventional wheel structure has an integrated weight. Thus, when a user rotates the conventional wheel structure with a general force, an inertia force of the integrated weight allows the conventional wheel structure to rotate at high-speed.

However, the conventional wheel structure that is able to rotate at high-speed needs the additional integrated weight, and therefore, the conventional wheel structure has high material and assembling costs and takes more time to assemble. Moreover, since a center of gravity of the conventional wheel structure is disposed at the integrated weight, when the conventional wheel structure rotates, the center of gravity of the conventional wheel structure changes constantly so the conventional wheel structure swings repeatedly so reducing comfort of use.

### SUMMARY OF THE INVENTION

The main objective of the present invention is to provide a wheel structure for an electronic input device. The wheel structure has a housing, and two supporting brackets and a circuit board mounted in the housing. A wheel assembly is supported by the supporting brackets and has a wheel. The wheel has an axle having a pivot end mounted through one supporting bracket and a mounting end mounted through a bearing disposed on the other supporting bracket. Moreover, a resilient assembly is disposed under and abuts the pivot end of the axle of the wheel.

The wheel assembly is floatingly disposed in the housing so a friction applied to the wheel assembly is reduced. Therefore, the user is able to rotate the wheel assembly at high-speed with a light force. Furthermore, material and assembling costs and an assembling time of the wheel structure are saved.

### BRIEF DESCRIPTION OF THE DRAWINGS

FIG. 1 is a perspective view of a wheel structure for an electronic input device in accordance with the present invention, a cover shown in phantom lines;

FIG. 2 is an enlarged exploded perspective view of the wheel structure in FIG. 1;

FIG. 3 is a front view in partial section of the wheel structure in FIG. 1;

FIG. 4 is an enlarged exploded perspective view of another embodiment of a wheel structure for an electronic input device in accordance with the present invention; and

FIG. 5 is another enlarged exploded perspective view of the wheel structure in FIG. 4.

### DETAILED DESCRIPTION OF THE PREFERRED EMBODIMENTS

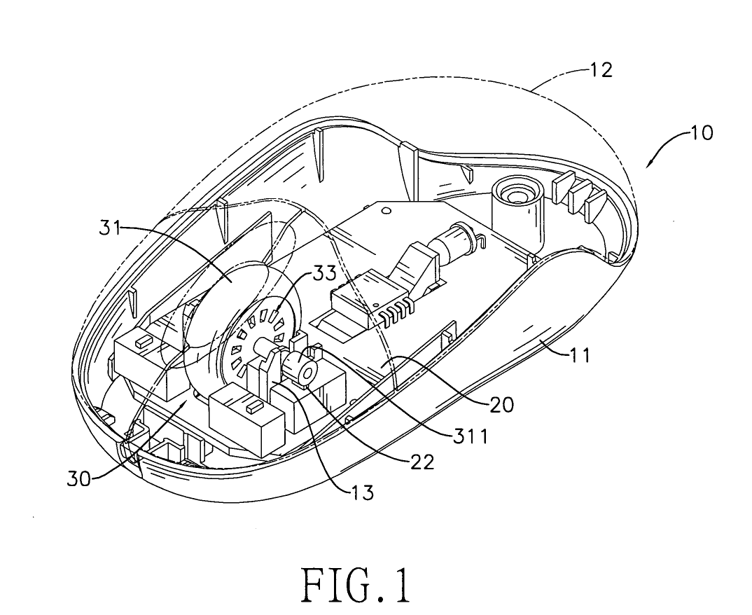

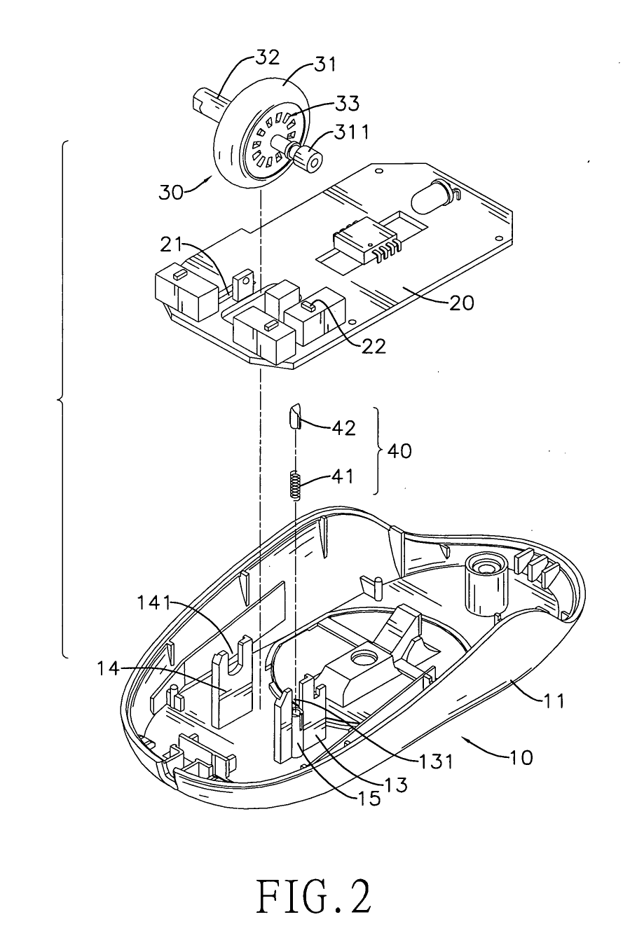

With reference to FIGS. 1 and 2, a wheel structure in accordance with the present invention is used for an electronic input device including but not limited to a mouse, a trackball, a tablet, a personal digital assistant (PDA), a keyboard, a game controller, and the like, and is preferably implemented as a mouse. The wheel structure in accordance with the present invention comprises a housing 10, a circuit board 20, a wheel assembly 30 and a resilient assembly 40, 40A.

The housing 10 comprises a cover 12 and a base 11 attached to each other and has a first supporting bracket 13 and a second supporting bracket 14. The first supporting bracket 13 is mounted on the base 11 of the housing 10 and has a slot 131 formed in an upper end of the first supporting bracket 13. A mounting tube 15 is formed in the housing 10 and is mounted in the slot 131 of the first supporting bracket 13. The second supporting bracket 14 is mounted on the base 11 of the housing 10, is separate from the first supporting bracket 13 and has a slot 141 formed in an upper end of the second supporting bracket 14.

The circuit board 20 is mounted on the base 11 of the housing 10 and has two through holes 21 and a micro switch 22. The through holes 21 are formed separately through the circuit board 20 and are mounted respectively around the first and second supporting brackets 13, 14. The micro switch 22 is disposed beside the first supporting bracket 13.

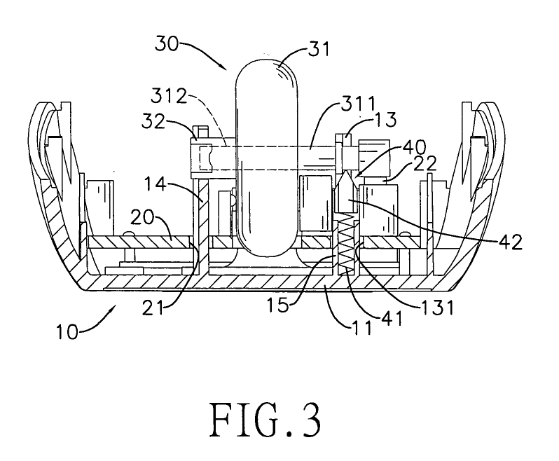

With further reference to FIG. 3, the wheel assembly 30 is mounted between and is supported by the first and second supporting brackets 13, 14 of the housing 10 and has a wheel 31 and a bearing 32. The wheel 31 has two opposite sides, a grating 33 and an axle. The grating 33 is mounted in the wheel 31. The axle is mounted axially through the wheel 31 and has a pivot end 311 and a mounting end 312. The pivot end 311 protrudes axially out from one side of wheel 31, is mounted through the slot 131 of the first supporting bracket 13 and corresponds to and selectively presses the micro switch 22. The mounting end 312 protrudes axially out from the other side of the wheel 31, is mounted through the slot 141 of the second supporting bracket 14. The bearing 32 is mounted around the mounting end 312 of the axle of the wheel 31 and is securely mounted in the slot 141 of the second supporting bracket 14 so the wheel 31 rotates smoothly.

The resilient assembly 40, 40A is mounted under and abuts the pivot end 311 of the axle of the wheel 31 so the pivot end 311 is floatingly disposed in the slot 131 of the first supporting bracket 13 and does not abut a bottom of the first supporting bracket 13. In a preferred embodiment, the resilient assembly 40 has a spring 41 and a slider 42. The spring 41 is mounted in the mounting tube 15 of the housing 10. The slider 42 is mounted in the mounting tube 15 of the housing 10 on the spring 41 and abuts the pivot end 311 of the axle of the wheel 31. Thus, when a user presses the wheel assembly 30, the pivot end 311 of the axle of the wheel 31 presses the micro switch 22 of the circuit board 20 accordingly and the micro switch 22 sends a signal. When the user releases the wheel assembly 30, the resilient assembly 40 pushes the pivot end 311 of the axle of the wheel 31 to separate the pivot end 311 from the micro switch 22. The micro switch 22 as described may be disposed beside an outer side of the first supporting bracket 13 that does not correspond to the wheel 31 and may be disposed between the first supporting bracket 13 and the wheel 31.

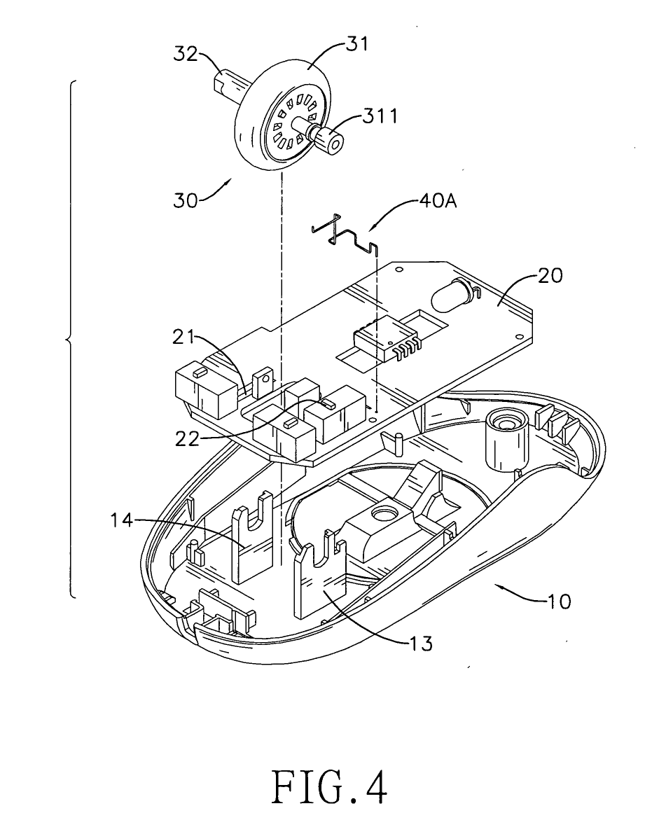

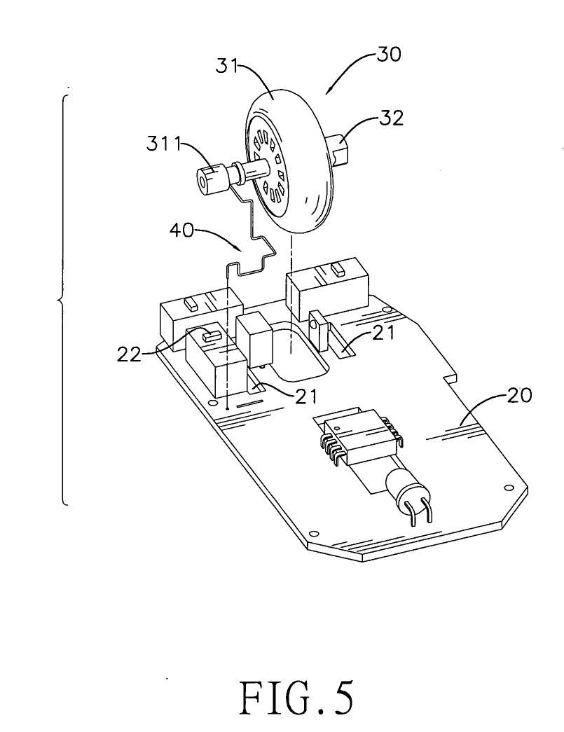

With further reference to FIGS. 4 and 5, in another preferred embodiment, the resilient assembly 40A is a bent and resilient metal wire and has a positioning segment, an upright segment and a supporting segment. The positioning segment of the resilient assembly 40A is securely mounted on the circuit board 20. The upright segment of the resilient assembly 40A protrudes longitudinally up from the positioning segment of the resilient assembly 40A and is disposed along and is securely mounted around the first supporting bracket 13. The supporting segment of the resilient assembly 40A protrudes transversely from the upright segment of the resilient assembly 40A and supports the pivot end 311 of the axle of the wheel 31. Therefore, the pivot end 311 of the axle of the wheel 31 is floatingly disposed in the slot 131 of the first supporting bracket 13 and the wheel assembly 30 resiliently return to its original position.

The wheel structure for the electronic input device as described has the following advantages. The bearing 32 and the resilient assembly 40, 40A that respectively support the pivot end 311 and the mounting end 312 of the axle of the wheel 31 allow the wheel assembly 30 to be floatingly disposed in the housing 10 so a friction applied to the wheel assembly 30 is reduced. Therefore, the user is able to rotate the wheel assembly 30 at high-speed with a light force and without an integrated weight disposed inside the wheel assembly 30. Moreover, material and assembling costs and an assembling time of the wheel structure are saved.

What is claimed is:

1. A wheel structure for an electronic input device comprising
a housing having
a first supporting bracket mounted in the housing and having a slot formed in an upper end of the first supporting bracket; and
a second supporting bracket mounted in the housing, being separate from the first supporting bracket and having a slot formed in an upper end of the second supporting bracket;
a circuit board mounted in the housing and having
two through holes formed separately through the circuit board and mounted respectively around the first and second supporting brackets; and
a micro switch disposed beside the first supporting bracket;
a wheel assembly mounted between and supported by the first and second supporting brackets of the housing and having
a wheel having
two opposite sides; and
an axle mounted axially through the wheel and having
a pivot end protruding axially out from one side of wheel, mounted through the slot of the first supporting bracket and corresponding to and selectively pressing the micro switch; and
a mounting end protruding axially out from the other side of wheel, mounted through the slot of the second supporting bracket; and
a bearing mounted around the mounting end of the axle of the wheel and securely mounted in the slot of the second supporting bracket; and
a resilient assembly mounted under and abutting the pivot end of the axle of the wheel.

2. The wheel structure as claimed in claim 1 further comprising a mounting tube, wherein
the mounting tube is formed in the housing and is mounted in the slot of the first supporting bracket; and
the resilient assembly has
a spring mounted in the mounting tube of the housing; and
a slider mounted in the mounting tube of the housing on the spring and abutting the pivot end of the axle of the wheel.

3. The wheel structure as claimed in claim 1, wherein the resilient assembly is a bent and resilient metal wire and has
a positioning segment securely mounted on the circuit board;
an upright segment protruding longitudinally up from the positioning segment of the resilient assembly and disposed along and securely mounted around the first supporting bracket; and
a supporting segment protruding transversely from the upright segment of the resilient assembly and supporting the pivot end of the axle of the wheel of the wheel assembly.

4. The wheel structure as claimed in claim 1, wherein the housing comprises a cover and a base attached to each other.

5. The wheel structure as claimed in claim 2, wherein the housing comprises a cover and a base attached to each other.

6. The wheel structure as claimed in claim 3, wherein the housing comprises a cover and a base attached to each other.

7. A wheel structure for an electronic input device comprising
a housing having a first supporting bracket and a second supporting bracket; and
a wheel assembly having a wheel having an axle mounted axially through the wheel and having a mounting end mounted with a bearing, and a grating mounted in the wheel; wherein
the wheel assembly is mounted between the first and second supporting brackets, the bearing is securely mounted on the second supporting bracket, a pivot end of the axle of the wheel is mounted through the first supporting bracket and is supported by a resilient assembly, and a micro switch is disposed under the pivot end of the axle of the wheel and beside the first supporting bracket.

8. The wheel structure as claimed in claim 7, wherein the micro switch is disposed beside an outer side of the first supporting bracket that does not correspond to the wheel.
